(19) United States
(12) Patent Application Publication
(10) Pub. No.: US 2002/0167909 A1
(43) Pub. Date: Nov. 14, 2002

(54) Method, system and service node for pre-paid service provision in packet data cellular telecommunication networks

(76) Inventors: Bartosz Balazinski, Montreal (CA); Jean-Francois Bertrand, Montreal (CA); Lila Madour, Kirkland (CA); John Barna, Beaconsfield (CA); Shohreh Savoli, Montreal (CA)

Correspondence Address: ANDRE M. SZUWALSKI, Jenkens & Gilchrist, P.C., 1445 Ross Avenue, Dallas, TX, 75202-2799, US

(21) Appl. No.: 09/850,268

(22) Filed: May 8, 2001

(51) Int. Cl. H04J 1/16

(52) U.S. Cl. 370/252; 370/329

(57) ABSTRACT

The present invention relates to a system, a method and a service node for providing a pre-paid service to a mobile station for data transmission in a packet data cellular telecommunication network. A connection is established between the mobile station and the service node in the packet data cellular telecommunication network. Upon establishment of the connection, at least one pre-paid connection limit parameter is obtained from a subscriber account database. The at least one pre-paid connection limit parameter is indicative of a limit at which the connection must be terminated. Then, the service node monitors the connection to determine whether the data transmission exceeds the at least one pre-paid connection limit parameter. If the data transmission exceeds the at least one pre-paid connection limit parameter, the connection is terminated.

### BACKGROUND OF THE INVENTION

1. Technical Field of the Invention

This invention relates generally to pre-paid services in packet data cellular telecommunication networks, and more particularly to a method and system for providing time and volume-based billing in a packet data cellular telecommunication network, in the context of pre-paid service provision to a mobile station.

2. Description of Related Art

Modem packet data cellular telecommunication networks allow mobile subscribers to benefit from a vast array of services. In the field of wireless communications, mobile stations support a wide variety of applications through which mobile subscribers, in addition to having conversations, can send text or vocal messages to other subscribers, and surf on the Internet.

This amounts to considerable traffic for network operators interested in providing those services to subscribers, but also generates interesting revenues. To this end, packet data cellular telecommunication networks are equipped with efficient service billing functions. The main billing methods used are time-based billing and volume-based billing.

In time-based billing, subscribers are subject to fees based on time, for instance on a per-second basis, with the time-based service rate varying according to the nature of the service. The service node handling the subscriber's connection thus monitors the duration of the call, and the corresponding fee is added to the subscriber's account in a database.

In volume-based billing, subscribers are subject to fees based on the amount of data transferred over their access network, the number of packets for instance. Again, the service node monitors the amount of data transferred, and the corresponding fee is added to the subscriber's account in a database.

Subscribers can also benefit from pre-paid services by registering funds in their account in advance. In this fashion, billing is performed by having, for example, the service node initially checking if there are sufficient funds in the subscriber's account held in the appropriate account database. Service provision is then initiated, and the service node continually monitors the amount of money remaining in the subscriber's account in the appropriate database. The amount of money stored in said appropriate database is decreased according to the fees associated with the service being provided, until the subscriber runs out of funds.

One disadvantage of the aforementioned billing method for providing pre-paid services lies in that it requires extensive signaling due to the continuous interaction between the service node handling the service provision and the database, as constant monitoring of the subscriber profile is required to verify that there remain sufficient funds in the subscriber's account to ensure the continuity of said service provision. This intensive signaling translates into additional traffic in the network, as well as additional processing in both the service node and the subscriber account database.

Indeed, verifying if sufficient funds remain in the subscriber's account once service provision has been initiated requires that the service node communicate with the appropriate database via a plurality of control signals. Conveyed by those signals are parameters which must thus periodically be transmitted back and forth between the service node and the database, said parameters reflecting if the service node should terminate or maintain the connection depending on whether or not sufficient funds remain in the subscriber's account. This process renders the service node dependent upon the database, in that it cannot autonomously handle the connection to the subscriber's mobile station without the assistance of the account database, from which it collects the relevant parameters dictating the appropriate course of action.

In order to overcome the limitations of current billing methods, it would be advantageous to have time-based as well as volume-based pre-paid service provision performed by an autonomous service node, which can monitor the connection for the entire duration of said service provision, without having to constantly communicate with a distant database for verification purposes, thereby reducing signaling and traffic in the network. The present invention provides such a solution.

### SUMMARY OF THE INVENTION

In one aspect, the present invention is a method for providing a pre-paid service to a mobile station for transmitting data in a packet data cellular telecommunication network. A connection is established between the mobile station and a service node in the packet data cellular telecommunication network, the service node providing access to the packet data cellular telecommunication network and monitoring the connection in accordance with pre-paid connection limit parameters obtained from an account database. Monitoring of the connection is achieved by determining at the service node whether parameters associated with the data transmitted over said connection exceed the limits defined by the obtained pre-paid connection limit parameters. If this proves to be the case, the service node terminates the connection.

In another aspect, the present invention is a system for providing a pre-paid service to a mobile station for transmitting data in a packet data cellular telecommunication network. An account database is used to store pre-paid connection limit parameters associated with the mobile station. A service node, to which the mobile station is connected, obtains from the account database the pre-paid connection limit parameters. The service node determines whether parameters associated with the data transmitted over said connection exceed the limits defined by the pre-paid connection limit parameters, and if so, terminates the connection.

In yet another aspect, the present invention is a service node for monitoring a PPP connection between a mobile station and a packet data cellular telecommunication network. The service node has a PPP stack, activated upon an establishment of the PPP connection between the mobile station and the packet data telecommunication network. The service node also includes a memory for storing pre-paid connection limit parameters obtained from an account database. Furthermore, the service node has a processor for comparing parameters associated with transmitted data with the pre-paid connection limit parameters. The processor determines whether the parameters associated with the transmitted data exceed the pre-paid connection limit parameters, and if so, commands the termination of the connection.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is an exemplary high-level network diagram of a packet data cellular telecommunication network according to a preferred embodiment of the invention;

FIG. 2A is an exemplary nodal operation and message flow diagram illustrating the establishment of a PPP connection in accordance with prior art;

FIG. 2B is an exemplary nodal operation and message flow diagram illustrating the different signaling parameters exchanged between the elements of the packet data cellular telecommunication network according to a preferred embodiment of the invention;

FIG. 3 is a flowchart diagram illustrating an exemplary procedure for monitoring a pre-paid connection at a service node according to a preferred embodiment of the invention;

FIG. 4 is a representation of an exemplary architecture of a service node used for monitoring a pre-paid connection between a mobile station and said service node, according to a preferred embodiment of the invention; and

FIG. 5 depicts a network configuration for monitoring an extendable pre-paid connection according to an alternative embodiment of the present invention.

### DETAILED DESCRIPTION OF EMBODIMENTS

Mobile stations, or wireless communication devices, allow mobile subscribers to benefit from a wide array of telephony services by establishing a connection with packet data cellular telecommunication networks. Radio access networks can interface with packet data cellular telecommunication networks, or computer networks, to allow for data transmission, or information exchange. Through various applications, data transmission services, such as telephony, e-mail messaging and access to the Internet, are thus available to mobile subscribers.

As mobile subscribers have the option to register funds in advance so that they may benefit from pre-paid services, an account database, or storing unit, is used to that effect. Databases in packet data cellular telecommunication networks comprise information about all mobile stations, and hence about all mobile subscribers. This cumulated information is referred to as the subscriber profile, which defines what services and options a given subscriber has subscribed to, and for the present matter, how much credit is registered to the subscriber's account for pre-paid service provision. The credit is thus the amount of money the subscriber has made available in advance to pay for services that will eventually be requested from said networks.

However, in a CDMA2000 (Code Division Multiple Access) network, a PDSN (Packet Data Service Node) interacting with an authentication node is limited by the latter as the authentication node only permits the PDSN to send periodic accounting information requests, which prevents continuous monitoring of service provision. In such conditions, pre-paid service provision and monitoring cannot be adequately performed. The present invention remedies this situation.

The description provided herein can apply to different network architectures, such as CDMA2000, CDMAone and GSM, regulated by different communication protocols such as CDMA and TDMA. The description applies as well to all systems based on a NAS (Network Access Server) to access the Internet.

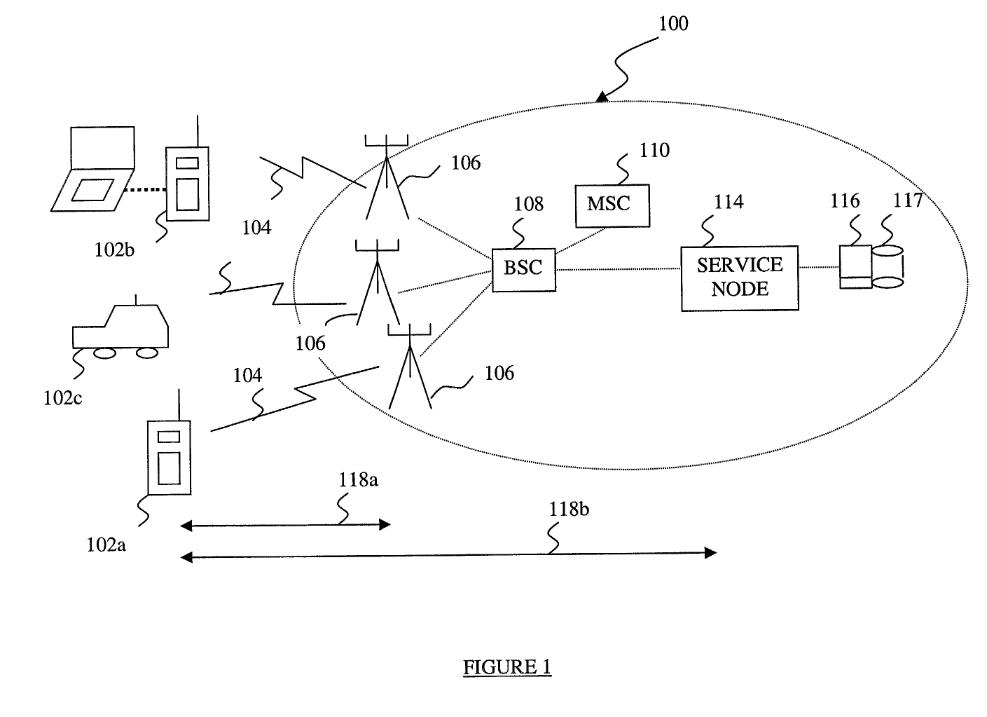

Reference is now made to FIG. 1, wherein there is shown, according to one embodiment of the invention, an exemplary highlevel network diagram of a packet data cellular telecommunication network 100.

Using a mobile station 102a (such as for example a mobile phone handset on its own 102a, linked to a computer 102b, or again a car radio unit 102c), a mobile subscriber establishes a first radio connection 118a over an air interface 104 with the packet data cellular telecommunication network 100 to benefit from telephony services. This information exchange over the air interface 104 can be regulated by any known communication protocols such as IS-54, IS-95 and IS-136, without being limited thereto.

The packet data cellular telecommunication network 100, of which a simple representation is provided for clarity considerations, thus exchanges information via radio signals with the mobile station 102a. To perform such radio communication, the packet data cellular telecommunication network 100 comprises equipment which includes Base Stations 106 (BS), Base Station Controllers (BSC) 108 and Mobile Services Switching Centers (MSC) 110.

The BSs 106 act as an interface between the mobile station 102a and the packet data cellular telecommunication network 100 equipment by performing two-way communications with the mobile station 102a over the air interface 104. The BSs 106 are further linked to one of the BSCs 108, which manage the allocation of radio resources. BSCs 108 ensure that mobile stations 102a are adequately assigned a channel, or frequency, for communication with at least one of the BSs 106. The BSCs 108 are in turn linked to one of the MSCs 110, which may perform switching functions within the packet data cellular telecommunication network 100, and authorizes the provision of mobile services for the mobile station 102a. It should be noted that the BSCs 108 could be incorporated within the MSCs 110 without departing from the scope of the present invention. For example, some standards, like IS-136 for instance, do not explicitly include BSCs 108 in their network reference models, as the MSCs 110 perform extended roles comprising that of the BSCs 108.

The packet data cellular telecommunication network 100 further comprises databases, or storing units, in which various information relating to mobile subscribers may be stored.

It is possible for the packet data cellular telecommunication network 100 to interact with another packet data cellular network (not shown) or an Internet, or public network, which may comprise as well a group of computers, linked together and able to communicate with each other, and which can exchange information through routers, or switches, via transmission links. Such networks can comprise web servers supporting web sites providing a variety of information and services to mobile as well as Internet subscribers.

The terminology “packet data” is used since the information, exchanged over the packet data cellular telecommunication network 100, is fragmented into packets. An Internet Protocol (IP) network is a packet data cellular telecommunication network 100 abiding by the aforementioned protocol.

Once the mobile station 102a has established a connection 118a with the radio equipment of the packet data cellular telecommunication network 100, the connection 118a can be further extended to a service node 114 in the packet data cellular telecommunication network 100, SO that the subscriber can benefit from services supported by the latter. To extend the connection 118a, the service node 114 is contacted. In specific network architectures, this service node 114 may be a Packet Data Service Node in a CDMA2000 network, or an Inter Working Function (IWF) in accordance with CDMAone or IS-136 standards.

The service node 114 performs authentication and authorization procedures prior to granting the mobile subscriber access to the network services. An authentication node 116, co-located with a subscriber account database 117, is used to perform authentication and prevent fraudulent use of the mobile station 102a. The authentication node 116 can be, without being limited thereto, a RADIUS (Remote Dial-In User Server) or a DIAMETER server for performing accounting, while the subscriber account database 117 can be co-located with the aforementioned authentication node 116, or located in a remote position in the network. The present invention can thus be extended to accommodate various AAA (Authorization, Authentication and Accounting) protocols.

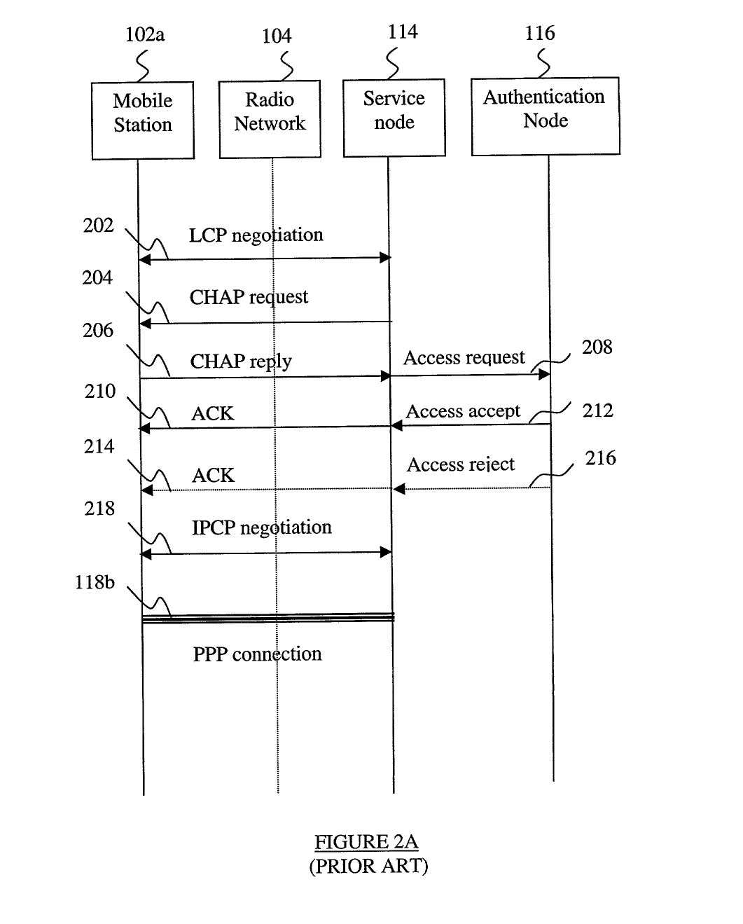

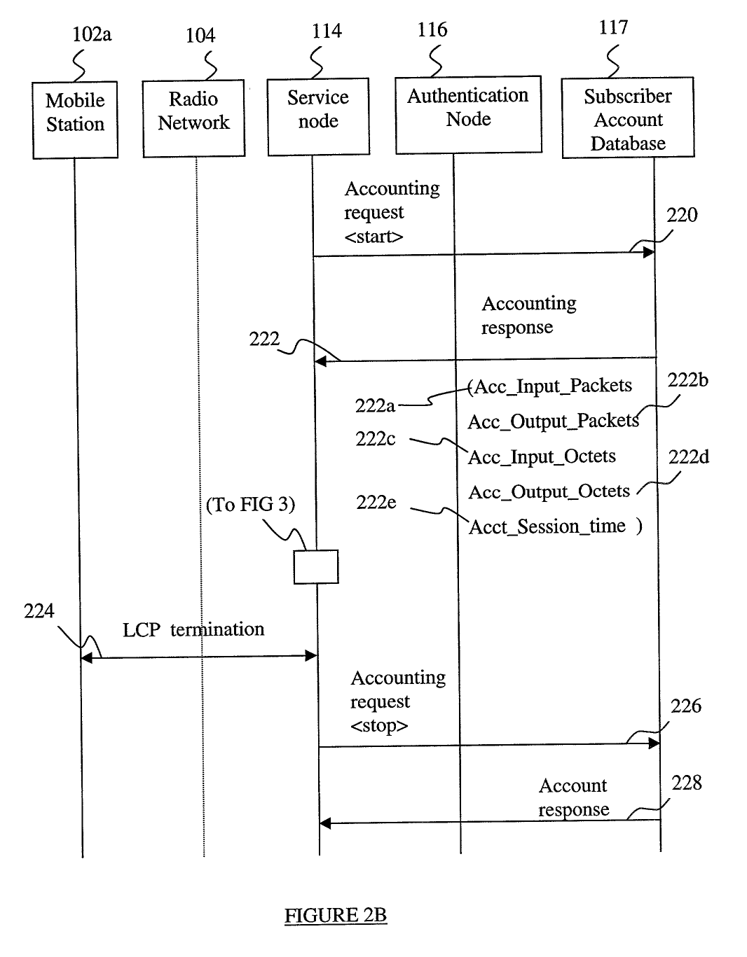

Reference is now jointly made to FIGS. 2A and 2B, wherein there is respectively shown, according to one embodiment of the invention, an exemplary nodal operation and message flow diagram illustrating the establishment of a PPP connection 118b in accordance with prior art, and an exemplary nodal operation and message flow diagram illustrating the different signaling parameters exchanged between the elements in the packet data telecommunication network 100.

The mobile station 102a and the service node 114 initiate the establishment of a PPP connection 118b (that will carry the IP protocol) by first negotiating the Link Control Protocol (LCP) via message 202. An authentication procedure, such as Challenge Authentication Protocol (CHAP) or Password Authentication Procedure (PAP), is then initiated. According to a preferred embodiment of the invention, a CHAP request message 204 is sent from the service node 114 to the mobile station 102a for authenticating the latter with the packet data telecommunication network 100. The mobile station 102a sends a CHAP reply message 206 to the service node 114. The service node 114 further forwards an access-request message 208 to the authentication node 116, which verifies the authentication data (e.g. username, password, etc), accounting data and all the service parameters (e.g. IP address etc.) in the subscriber account database 117 prior to authorizing the mobile station 102a to benefit from requested services.

This authentication request with the authentication node 116 is accepted via an access-accept message 212 or rejected via an access-reject message 216, outcome which is relayed to the mobile station 102a respectively via acknowledge messages 210 and 214. Internet Protocol Control Protocol (IPCP) negotiation 218 is performed in parallel with the authentication process, and leads to the establishment of a Point-to-Point Protocol (PPP) connection 118b between the mobile station 102a and the service node 114. Further detail for PPP connection establishment may be obtained from technical specifications manuals such as “IS-835 for CDMA2000 cellular telecommunication networks”, herein included by reference.

According to a preferred embodiment of the invention, the mobile subscriber uses a mobile station 102a to establish a first radio connection 118a with a CDMA2000 packet data cellular telecommunication network 100. Through the packet data cellular telecommunication network 100, the mobile station 102a further extends the connection 118a to the service node 114, referred to as a Packet Data Service Node (PDSN), in an IP network, the extended connection being viewed as a single PPP connection 118b.

Once the PPP connection 118b is established, the service node 114 sends to the subscriber account database 117 an accounting request message 220 with the “start” attribute. The subscriber account database 117 replies with an accounting-response message 222, which includes pre-paid connection limit parameters 222a, 222b, 222c, 222d and 222e associated with the mobile station 102a. These pre-paid connection limit parameters 222a, 222b, 222c, 222d and 222e are standard attributes, extracted from the subscriber account database 117, and can be time or volume related so that time-based billing, volume-based billing, or both, may be performed. The aforementioned pre-paid connection limit parameters 222a, 222b, 222c, 222d and 222e being included in the accounting-response message informs the service node 114 that pre-paid service provision is requested. According to current standards, the pre-paid connection limit parameters 222a, 222b, 222c, 222d and 222e are only used in the context of an accounting request message 226 including a “stop” attribute. In accordance with the present invention, these parameters 222a, 222b, 222c, 222d and 222e are included in the accounting-response message 222 as well. Alternatively, those parameters can as well be sent in the access-accept message 212.

The pre-paid connection limit parameters 222a, 222b, 222c, 222d and 222e may be pre-paid connection time limit parameters and pre-paid connection traffic limit parameters, respectively associated with time-based billing and volume-based billing. The pre-paid connection time limit parameters may thus be parameters indicating an allowed duration of the connection, and the pre-paid connection traffic limit parameters may be parameters indicating how much data can be transmitted over the connection. The data may comprise any type of information transferred between the mobile station 102a and the packet data cellular telecommunication network 100, and may be expressed in a plurality of units such as for example, packets, frames, bytes (or octets) and bits.

According to a preferred embodiment of the present invention, the pre-paid connection time limit parameters 222a, 222b, 222c, 222d and 222e may be an Acct-Session-Time parameter 222e, which specifies a maximum duration of the PPP connection 118b, or a maximum duration for data transmission over the PPP connection 118b. Furthermore, the pre-paid connection traffic limit parameters 222a, 222b, 222c, 222d and 222e may be an Acct-Input-Packets parameter 222a, which defines the maximum allowed number of packets which may be transferred up-link (from the mobile station 102a to the service node 114) over the PPP connection 118b, an Acct-Output-Packets parameter 222b, which defines the maximum allowed number of packets which may be transferred down-link (from the service node 114 to the mobile station 102a) over the PPP connection 118b, an Acct-Input-Octets parameter 222c, which defines the maximum allowed number of octets which may be transferred up-link over the PPP connection 118b, and an Acct-Output-Octets parameter 222d, which defines the maximum allowed number of octets which may be transferred down-link over the PPP connection 118b.

These pre-paid connection limit parameters 222a, 222b, 222c, 222d and 222e are defined in current authentication standards but are however not used in the accounting-response message 222. The service node 114, upon receiving at least one of the pre-paid connection limit parameters 222a, 222b, 222c, 222d and 222e can autonomously monitor the PPP connection 118b with the mobile station 102a.

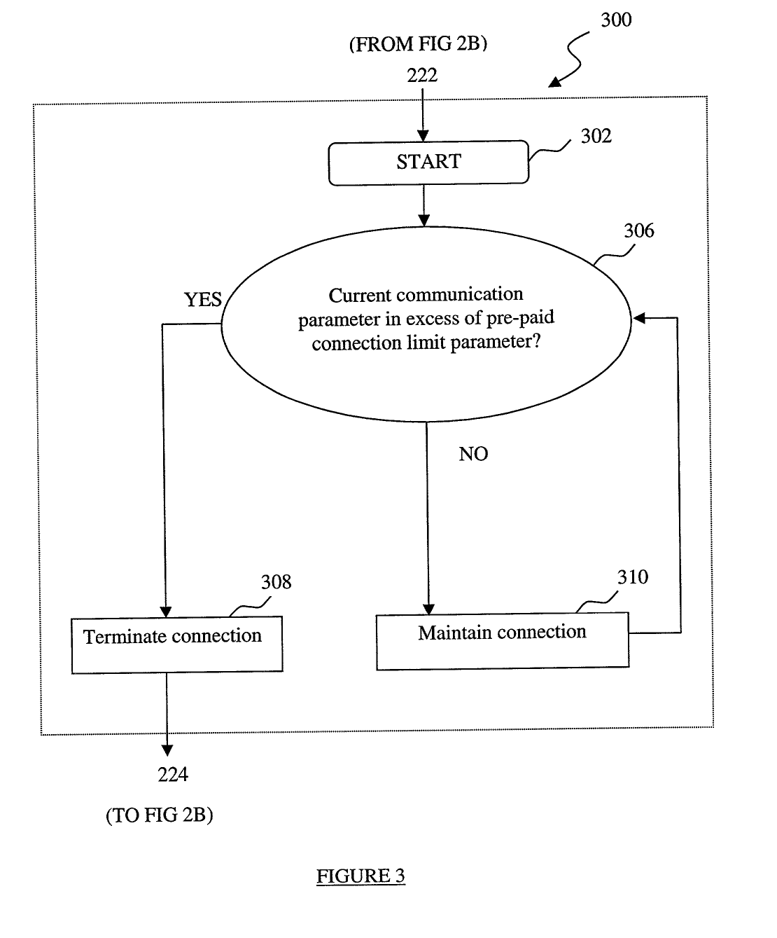

Reference is now as well made to FIG. 3, wherein there is shown a flowchart diagram illustrating an exemplary procedure for monitoring the pre-paid connection at the service node 114 according to a preferred embodiment of the invention. The service node 114 receives at least one of the pre-paid connection limit parameters 222a, 222b, 222c, 222d and 222e, step 302. The service node 114 then monitors the PPP connection 118b by comparing the time for which said PPP connection 118b has been maintained to the maximum duration allowed for the PPP connection 118b, said maximum duration defined by the pre-paid connection time limit parameter 222e. The service node 114 may concurrently also monitor the PPP connection 118b by comparing the amount of data transferred over the PPP connection 118b with the authorized amount of data which may be transferred over said PPP connection 118b, said amount of data defined by one of the pre-paid connection volume-based parameters 222a, 222b, 222c and 222d.

The service node 114 may thus monitor the PPP connection 118b with respect to one of the two previously mentioned aspects, or compare both criteria simultaneously. The comparing and monitoring is performed in step 306. When a threshold defined by one of the pre-paid connection limit parameters 222a, 222b, 222c, 222d and 222e is exceeded, the PPP connection 118b is terminated by the service node 114 with an LCP termination message 224, step 308. As long as the threshold is not exceeded, the PPP connection 118b is maintained, step 310, and monitoring of said PPP connection 1 18b resumes, step 306.

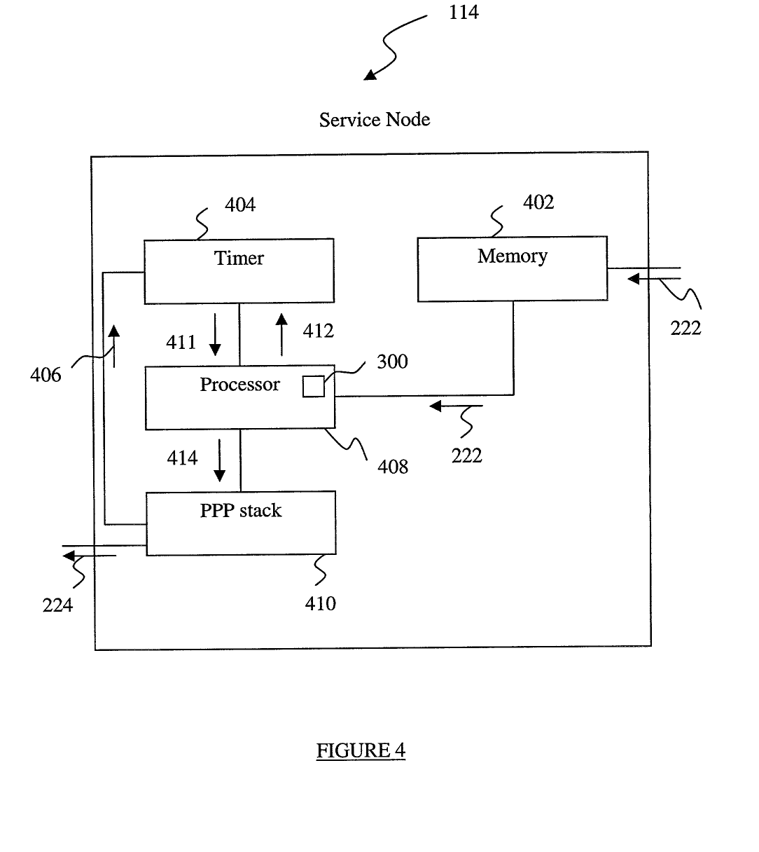

Reference is now as well made to FIG. 4, wherein there is shown a representation of an exemplary architecture of the service node 114 used for monitoring the pre-paid PPP connection 118b between the mobile station 102a and said service node 114 in the packet data cellular telecommunication network 100 according to a preferred embodiment of the invention. Monitoring is performed by a call supervision function 300 run on a processor 408 of the service node 114. Are encompassed within the call supervision function 300 all the monitoring steps described in FIG. 3. The call supervision function 300 is activated upon receipt of at least one of the pre-paid connection limit parameters 222a, 222b, 222c, 222d and 222e included in the accounting-response message 222 from the subscriber account database 117, better shown in FIG. 2B. Reception of one of those parameters 222a, 222b, 222c, 222d and 222e indicates that pre-paid service is to be initiated.

Upon receipt of at least one of the pre-paid connection limit parameters 222a, 222b, 222c, 222d and 222e, the pre-paid parameter is stored in a memory 402 of the service node 114. The memory provides the service node's 114 internal processor 408 with the stored pre-paid connection parameter so that the processor 408 can compare, in step 306 of FIG. 3, the current connection parameters with at least one of the pre-paid connection limit parameters 222a, 222b, 222c, 222d and 222e to determine, step 306, whether or not one of the former exceeds the latter. To this end, the processor 408 requests from a timer 404, via message 412, the current duration of the current PPP connection 118b, or of the data transmission, whichever is preferred. This information is returned to the processor via message 411. The processor 408 further retrieves the pre-paid connection limit parameter 222e from the memory 402. In the event that the PPP connection 118b is to be terminated, as determined in step 306, the processor sends a termination message 414 to the PPP stack 410 to that effect. The timer 404 may be later restarted by the PPP stack 410 via a message 406 upon the establishment of a new PPP connection 118b with the service node 114.

Following the termination of the PPP connection 118b, step 308, the service node 114 sends to the subscriber account database 117 an accounting-request message 226 comprising an Acct-Terminate-cause message comprised in the accounting-request message 226, which indicates the cause for call termination, as well as the connection accounting parameters indicating for how long the connection has been maintained and how much data has been transferred over said connection. The Acct-Terminate-cause message also specifies whether one of the pre-paid connection traffic or time limit has been exceeded. Upon reception of this message 226, the subscriber account database 117 updates the information in the subscriber profile stored in the subscriber account database 117 and sends an account-response reply 228 to the service node 114.

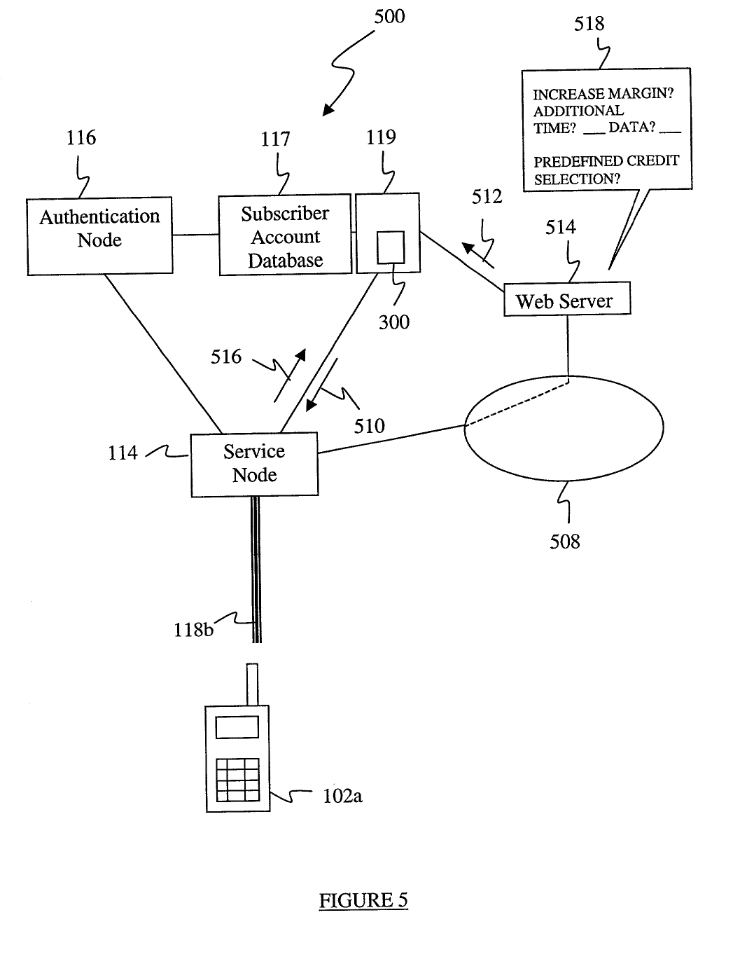

Reference is now jointly made to FIG. 2B, wherein there is shown an exemplary nodal operation and message flow diagram illustrating the different signaling parameters exchanged between the elements of the packet data cellular telecommunication network according to a preferred embodiment of the invention, and FIG. 5, wherein is depicted, according to an alternative embodiment of the present invention, a network configuration 500 for monitoring an extendable pre-paid connection.

In this alternative embodiment, preferably implemented with the DIAMETER protocol, the call supervision function 300 is comprised in a prepaid server entity 119, which can for instance be co-located with the subscriber account database 117. The pre-paid server entity 119 may alternatively be located in another node in the network. In this fashion, the prepaid server entity 119 now monitors the prepaid service provision to the mobile station 102a. Monitoring is performed via an accounting message 516 periodically received from the service node 114, said accounting message 516 specifying the amount of data transmitted over the PPP connection 118b or the time for which said connection 118b has been maintained. Based on this accounting message 516, the prepaid server entity 119, relying on its call supervision function 300, is responsible for determining that the PPP connection 118b is to be terminated. Therefore, if the call supervision function 300 within the prepaid server entity 119 determines that the PPP connection 118b is to be terminated, it forwards a session termination message 510 to the service node 114 and the latter disconnects the appropriate connection 118b.

Still in accordance with this alternative embodiment, the mobile station 102a can opt to extend the duration of the PPP connection 118b or the amount of data which may transferred over said PPP connection 118b before one of the pre-paid connection limit parameters 222a, 222b, 222c, 222d and 222e is exceeded. To do so, the mobile station 102a may for instance, via the Internet 508, access a web site and purchase, via a Graphical User Interface (GUI) 518, an additional amount of data which can be transferred over the PPP connection 118b before its termination or an additional time extension so as to prolong its duration. These transactions are processed by a web server 514 that subsequently sends an account update message 512 to the prepaid server entity 119, thereby dynamically updating the subscriber account database 117 with the new mobile station 102a additional credit. Alternatively, the pre-paid server entity 119 can, before the expiry of the subscriber credit in the subscriber account database 117, notify the mobile station 102a with a warning message or again invite the latter to purchase more credit via the web server 514.

This last embodiment allows for a more flexible prepaid service provision as the mobile station 102a is not confined to benefiting from a pre-determined prepaid credit limit. Moreover, the dynamic updating of the subscriber account database 117 by a distant node, the web server 514 in the present case, is rendered possible by the displacement of the call supervision function 300 in the pre-paid server entity 119, such that the prepaid service provision monitoring is performed with respect to the updated co-located subscriber account database 117 credit information.

It is thus believed that the operation and construction of the present invention will be apparent from the foregoing description. While the method and system shown and described has been characterized as being preferred, it will be readily apparent that various changes and modifications could be made therein without departing from the spirit and scope of the invention as defined in the following claims.

What is claimed is:

1. A method for providing a pre-paid service to a mobile station for data transmission in a packet data cellular telecommunication network, the method comprising the steps of:
establishing a connection between the mobile station and a service node in the packet data cellular telecommunication network;
responsive to the establishment of the connection, obtaining from a subscriber account database at least one pre-paid connection limit parameter indicative of a limit at which the connection must be terminated; and
monitoring at the service node the connection to determine whether the data transmission exceeds the at least one pre-paid connection limit parameter, and if so, terminating the connection.

2. The method as in claim 1, wherein the at least one pre-paid connection limit parameter includes a pre-paid connection time limit parameter.

3. The method as in claim 2, wherein the pre-paid connection time limit parameter is a parameter indicative of a maximum duration of the connection.

4. The method as in claim 3, wherein monitoring of at least one current connection parameter is performed by comparing a current duration of the connection with the pre-paid connection time limit parameter.

5. The method as in claim 1, wherein the at least one pre-paid connection limit parameter includes a pre-paid connection traffic limit parameter.

6. The method as in claim 5, wherein the pre-paid connection traffic limit parameter is a parameter indicative of a maximum amount of data that can be transmitted over the connection.

7. The method as in claim 6, wherein the pre-paid connection traffic limit parameter limits the amount of data that can be transmitted up-link over the connection.

8. The method as in claim 6, wherein the pre-paid connection traffic limit parameter limits the amount of data that can be transmitted down-link over the connection.

9. The method as in claim 6, wherein the pre-paid connection traffic limit parameter limits the total amount of data that is to be transmitted over the connection.

10. The method as in claim 6, wherein a quantitative unit of the pre-paid connection traffic limit parameter is selected from a group of quantitative units consisting of: packets, frames, bytes and bits.

11. The method as in claim 6, wherein monitoring of at least one current connection parameter is performed by comparing a current amount of data transmitted over the connection with the pre-paid connection traffic limit parameter.

12. The method as in claim 1, wherein:
the connection between the mobile station and the service node in the packet data cellular telecommunication network is established through a radio access network;
the connection is a Point-to-Point (PPP) connection;
the packet data cellular telecommunication network is an Internet Protocol (IP) network;
the packet data cellular telecommunication network is accessed via a Packet Data Service Node (PDSN) in a CDMA2000 network; and the subscriber account database is co-located with a RADIUS.

13. The method as in claim 12, wherein the subscriber account database is co-located with a DIAMETER server.

14. The method as in claim 12, wherein the subscriber account database is located in a remote node in the packet data cellular telecommunication network.

15. The method as in claim 1, wherein before the exceeding of the at least one pre-paid connection limit parameter, the mobile station increases the value of said at least one pre-paid connection limit parameter.

16. The method as in claim 15, wherein the mobile station increases the value of said at least one pre-paid connection limit parameter via a web site.

17. The method as in claim 15, wherein the mobile station increases the value of said at least one pre-paid connection limit parameter by selecting via a graphical user interface one of a predefined additional amount of data which can be transmitted over the connection and a predefined additional amount of time for which the connection can be maintained.

18. The method as in claim 15, wherein the mobile station increases the value of the at least one pre-paid connection limit parameter by specifying via a graphical user interface one of a predefined additional amount of data which can be transmitted over the connection and a predefined additional amount of time for which the connection can be maintained.

19. The method as in claim 15, wherein the mobile station is notified when a predefined value of the at least one pre-paid connection limit parameter is attained.

20. A system for providing a pre-paid connection service for data transmission to a mobile station in a packet data cellular telecommunication network, the system comprising:
a subscriber account database for storing for the mobile station, at least one pre-paid connection limit parameter; and
a service node for:
supporting the establishment of a connection between the mobile station and the packet data cellular telecommunication network;
obtaining from the subscriber account database the at least one pre-paid connection limit parameter; and
during the connection, determining whether the data transmission exceeds the at least one pre-paid connection limit parameter and if so, terminating the connection.

21. The system as in claim 20, wherein the at least one pre-paid connection limit parameter includes a pre-paid connection time limit parameter.

22. The system as in claim 21, wherein the pre-paid connection time limit parameter is a parameter indicative of a maximum duration of the connection.

23. The system as in claim 22, wherein monitoring of at least one current connection parameter is performed by comparing a current duration of the connection with the pre-paid connection time limit parameter.

24. The system as in claim 20, wherein the at least one pre-paid connection limit parameter includes a pre-paid connection traffic limit parameter.

25. The system as in claim 24, wherein the pre-paid connection traffic limit parameter is a parameter indicative of a maximum amount of data that can be transmitted over the connection.

26. The system as in claim 25, wherein the pre-paid connection traffic limit parameter limits the amount of data that can be transmitted up-link over the connection.

27. The system as in claim 25, wherein the pre-paid connection traffic limit parameter limits the amount of data that can be transmitted down-link over the connection.

28. The system as in claim 25, wherein the pre-paid connection traffic limit parameter limits the total amount of data that can be transmitted over the connection.

29. The system as in claim 25, wherein a quantitative unit of the pre-paid connection traffic limit parameter is selected from a group of quantitative units consisting of: packets, frames, bytes and bits.

30. The system as in claim 25, wherein monitoring of at least one current connection parameter is performed by comparing a current amount of data transmitted over the connection with the pre-paid connection traffic limit parameter.

31. The system as in claim 20, wherein:
the service node manages the connection between the mobile station and the packet data cellular telecommunication network;
the connection is a Point-to-Point (PPP) connection;
the packet data cellular telecommunication network is an Internet Protocol (IP) network;
the packet data cellular telecommunication network is accessed via a Packet Data Service Node (PDSN) in a CDMA2000 network; and the subscriber account database is co-located with a RADIUS.

32. The system as in claim 31, wherein the subscriber account database is co-located with a DIAMETER server.

33. The system as in claim 31, wherein the subscriber account database is located in a remote node in the packet data cellular telecommunication network.

34. The system as in claim 20, wherein before the exceeding of the at least one pre-paid connection limit parameter, the mobile station increases the value of said at least one pre-paid connection limit parameter.

35. The system as in claim 34, wherein the mobile station increases the value of said at least one pre-paid connection limit parameter via a web site.

36. The system as in claim 35, wherein the mobile station increases the value of said at least one pre-paid connection limit parameter by selecting via a graphical user interface one of a predefined additional amount of data which can be transmitted over the connection and a predefined additional amount of time for which the connection can be maintained.

37. The system as in claim 35, wherein the mobile station increases the value of said at least one pre-paid connection limit parameter by specifying via a graphical user interface one of a predefined additional amount of data which can be transmitted over the connection and a predefined additional amount of time for which the connection can be maintained.

38. The system as in claim 34, wherein the mobile station is notified when a predefined value of the at least one pre-paid connection limit parameter is attained.

39. A service node for monitoring a PPP connection between a mobile station transmitting data and a packet data cellular telecommunication network, the service node comprising:
a PPP stack, activated upon an establishment of the PPP connection between the mobile station and the packet data telecommunication network;
a memory for storing at least one pre-paid connection limit parameter; and
a processor for comparing the transmitted data with the at least one pre-paid connection limit parameter, wherein the processor terminates the PPP connection if the transmitted data exceeds the at least one pre-paid connection limit parameter.

40. The service node as in claim 39, wherein the at least one prepaid connection limit parameter includes a pre-paid connection time limit parameter.

41. The service node as in claim 40, wherein the pre-paid connection time limit parameter is a parameter indicative of a maximum duration of the PPP connection.

42. The service node as in claim 41, wherein monitoring of at least one current connection parameter is performed by comparing a current duration of the PPP connection with the pre-paid connection time limit parameter.

43. The service node as in claim 39, wherein the at least one pre-paid connection limit parameter includes a pre-paid connection traffic limit parameter.

44. The service node as in claim 43, wherein the pre-paid connection traffic limit parameter is a parameter indicative of an amount of data that can be transmitted over the PPP connection.

45. The service node as in claim 44, wherein the pre-paid connection traffic limit parameter limits the amount of data that can be transmitted up-link over the PPP connection.

46. The service node as in claim 44, wherein the pre-paid connection traffic limit parameter limits the amount of data that can be transmitted down-link over the PPP connection.

47. The service node as in claim 44, wherein the pre-paid connection traffic limit parameter limits the total amount of data that can be transmitted over the PPP connection.

48. The service node as in claim 44, wherein a quantitative unit of the pre-paid connection traffic limit parameter is selected from a group of quantitative units consisting of: packets, frames, bytes and bits.

49. The service node as in claim 44, wherein monitoring of at least one current pre-paid connection parameter is performed by comparing a current amount of data transmitted over the PPP connection with the pre-paid connection traffic limit parameter.

50. The service node as in claim 39, wherein:
the PPP connection between the mobile station and the packet data cellular telecommunication network is established through a radio access network;
the packet data cellular telecommunication network is an Internet Protocol (IP) network;
the packet data cellular telecommunication network is accessed via a Packet Data Service Node (PDSN) in a CDMA2000 network; and
the subscriber account database is co-located with a RADIUS.

51. The service node as in claim 50, wherein the subscriber account database is co-located with a DIAMETER server.

52. The service node as in claim 50, wherein the subscriber account database is located in a remote node in the packet data cellular telecommunication network.

53. The service node as in claim 39, wherein be fore the exceeding of the at least one pre-paid connection limit parameter, the mobile increases the value of said at least one pre-paid connection limit parameter.

54. The service node as in claim 53, wherein the mobile station increases the value of said at least one pre-paid connection limit parameter via a web site.

55. The service node as in claim 54, wherein the mobile station increases the value of said at least one pre-paid connection limit parameter by selecting via a graphical user interface one of a predefined additional amount of data which can be transmitted over the connection and a predefined additional amount of time for which the connection can be maintained.

56. The service node as in claim 54, wherein the mobile station increases the value of said at least one pre-paid connection limit parameter by specifying via a graphical user interface one of a predefined additional amount of data which can be transmitted over the connection and a predefined additional amount of time for which the connection can be maintained.

57. The service node as in claim 53, wherein the mobile station is notified when a predefined value of the at least one pre-paid connection limit parameter is attained.
